(19) United States
(12) Patent Application Publication
(10) Pub. No.: US 2002/0189336 A1
(43) Pub. Date: Dec. 19, 2002

(54) Radar monitoring system for tires and wheels

(75) Inventor: Thomas E. McEwan, Carmel Highlands, CA (US)

Correspondence Address: HAYNES BEFFEL & WOLFELD LLP, P O BOX 366, HALF MOON BAY, CA, 94019, US

(73) Assignee: McEwan Technologies, LLC, Monterey, CA

(21) Appl. No.: 09/882,595

(22) Filed: Jun. 15, 2001

(51) Int. Cl. G01M 17/02

(52) U.S. Cl. 73/146

(57) ABSTRACT

A non-contact radar sensor detects tire abnormalities such as tread delamination, sidewall ballooning, embedded nails, and impending flat or hazardous tires. The sensor also detects tire and wheel geometry errors such as out-of-round and run-out. Wheel rotational rate can be sensed for use as a speedometer or for detection of wheel lockup during braking, particularly for large trucks, or for detection of wheel slip in four-wheel drive and racing vehicles. Information from the radar sensor may be used to alert the driver or to control an antilock braking system or a traction control system. The radar sensor is preferably a range-gated 24 GHz pulse Doppler radar with spread spectrum emissions to permit four or more to operate on a single vehicle in an environment crowded with similar sensors.

### BACKGROUND OF THE INVENTION

1. Field of the Invention

The present invention relates to radar sensors, and more particularly to radar sensors for monitoring tire condition and speed.

2. Description of Related Art

Prior electronic tire monitoring efforts have focused mainly on the measurement and telemetry of tire pressure using a pressure sensor and wireless transmitter located inside the tire. Radar has seen limited use in monitoring the ground speed of cars and trains. U.S. Pat. No. 5,764,162, “Micropower Impulse Radar Based Wheel Detector,” to Ehrlich discloses the use of radar for trackside monitoring of passing railroad wheels.

### SUMMARY OF THE INVENTION

The present invention is a radar mounted on a vehicle or a test fixture and having a beam directed to a rotating tire or wheel rim. Output signals from the radar are processed to detect tire abnormalities or defects such as tread delaminations, embedded nails, out-of-round tires, tire run-out (or lateral wobble), and sidewall bulges (ballooning). Wheel speed can also be detected on a non-contact basis.

When the radar beam is directed to a tire tread, the radar output signal is related to the tread pattern and wheel speed. A consistent signal indicates a consistent tread pattern, whereas periodic inconsistencies indicate a tread abnormality such as tread delamination, i.e., loose or missing tread or a flat spot. A burst in the radar output that occurs at the same rate as the wheel revolution rate may indicate a nail embedded in the tread, which could signal an imminent flat tire or blowout. Similarly, the radar may be beamed at the sidewall of the tire to detect an abnormal, localized bulge (ballooning).

When the radar is beamed at a spoked wheel rim or a rim containing at least one spoke-like irregularity, the radar output is a signal proportional to the number of spokes passing through the radar beam per unit time. Accordingly, wheel speed can be measured on a non-contact basis.

The radar is preferably a range-gated pulse-Doppler radar having its range-gated region centered on the tire or wheel region of interest in a manner that excludes clutter from, for example, the passing ground under the vehicle or clutter from wheel well motion. Range-gating also limits the size of the detection zone to provide a better-defined signal. For example, the range gate spatial width might be limited to less than one spoke interval (or tread spacing) to provide a cleaner signal for spoke counting (or tread pattern processing). A further aspect of the pulse Doppler radar is its inherently spread-spectrum nature due to the shortness of the emitted pulses-generally less than 10 nanoseconds—and the typical use of a dithered pulse rate. Also, the receive pulses are coherently integrated so the desired radar returns build to a cleaner signal while interference integrates to zero. Of course, other types of radar may also be used. is

A primary object of the present invention is to provide a non-contact tire abnormality detector, such as for tread delamination, sidewall ballooning, and embedded nails.

A further object of the present invention is to provide a non-contact geometrical error detector such as for out-of-round tires and tire run-out (lateral wobble).

Another object of the present invention is to provide a non-contact wheel speed sensor.

Yet another object of the present invention is to control a system of a vehicle in response to detected tire condition or wheel speed information.

Uses for the present invention include non-contact tire abnormality and safety monitoring, flat-tire early warning detection, wheel lockup detection (particularly for large trucks), wheel slip sensing for anti-lock brake systems, and wheel slip control systems in four-wheel drive and racing vehicles. The invention may be implemented either on a vehicle or on a test fixture. When mounted on a test fixture, manufacturing processes and quality may be monitored such as tread or tire cord uniformity. When mounted on a test fixture at a repair station, tires may be quickly scanned for tire geometry errors, embedded nails, ballooning, and other abnormalities.

### BRIEF DESCRIPTION OF THE DRAWINGS

FIG. 1 depicts a tire tread monitoring system of the present invention.

FIG. 2 depicts a tire sidewall monitoring system of the present invention.

FIG. 3 depicts a wheel rim speed detection system of the present invention.

FIG. 4 plots Doppler radar signals of the present invention from tread having an embedded metal screw on a rotating tire.

FIG. 5 plots Doppler radar signals of the present invention from tread on a rotating tire.

FIG. 6 plots Doppler radar signals of the present invention from spokes on the rim of a rotating tire.

### DETAILED DESCRIPTION OF THE INVENTION

A detailed description of the present invention is provided below with reference to the Figures. All US Patents and copending US applications cited herein are herein incorporated by reference.

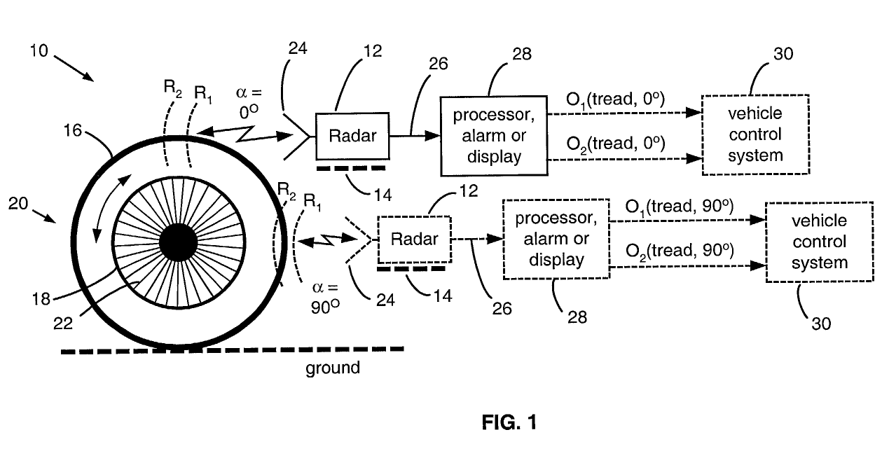

FIG. 1 is a block diagram of a radar monitoring system 10 of the present invention positioned for tread monitoring. A radar (or transmitter-receiver, or transceiver apparatus) 12 is mounted on a vehicle structural element 14, which is separate from wheel assembly 20 is operatively connected. Alternatively, structural element 14 may be part of a test stand or fixture on which wheel assembly 20 or tire 16 is mounted. Structural element 14 may be a wheel well or a non-rotating wheel axle of the same vehicle to which wheel assembly 20 is operative. Wheel assembly 20 is typically comprised of a tire 16 and a wheel or rim 18. In some cases, tire 16 is absent and wheel assembly 20 is entirely comprised of a metal “rim” i.e., a railroad wheel or a military tank wheel. Rim 18 may include one or more spokes 22.

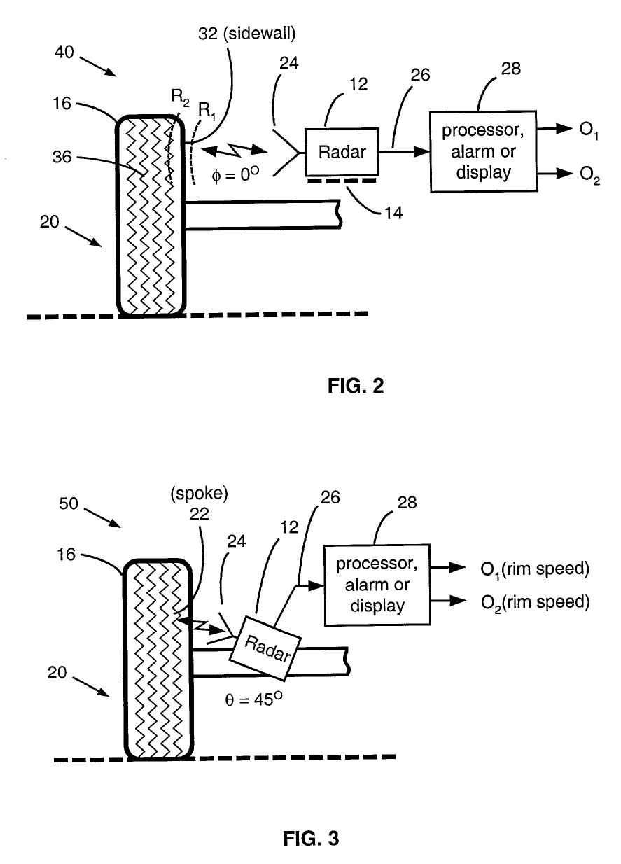

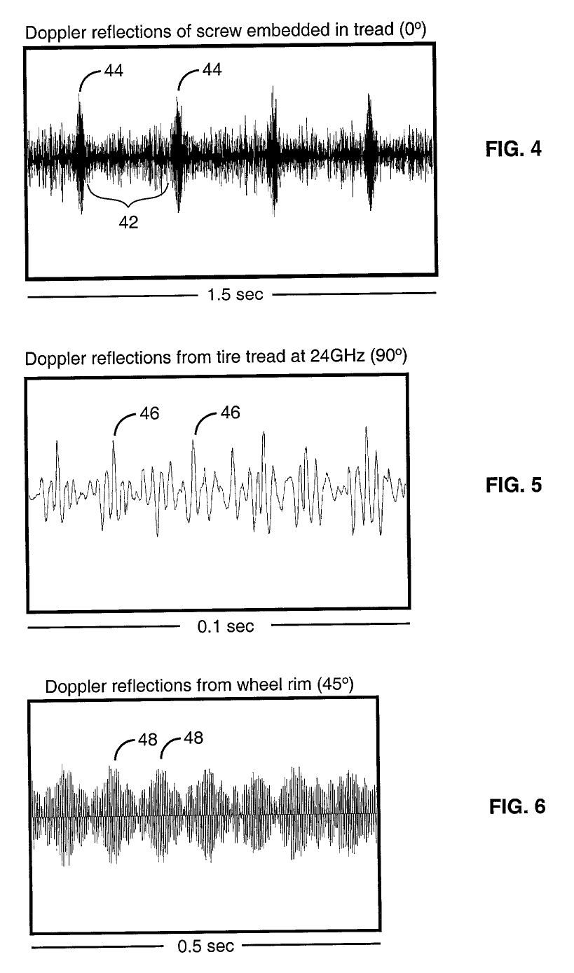

Radar antenna 24 beams RF energy to tread 36 (shown in FIG. 2) at a substantially grazing, or 0-degree, angle. The RF energy is reflected from the tire tread with a Doppler shift proportional to wheel speed and the cosine of the angle between the radar beam and the tread motion, i.e., the Doppler frequency shift F_{dop} is proportional to the tangential tread velocity Vₜ and the RF center frequency F_{RF}, or F_{dop}=2F_{RF}(Vₜ/C)cos α, where c=3×10⁸ m/s and α= the angle between the radar beam and the tread motion. RF center frequency F_{RF} is typically 24 GHz. The Doppler shift is detected by radar 12 and output on interconnect 26 to processor 28. A Doppler signal is plotted in FIG. 4 for a tread with an abnormality. The normal Doppler signal is illustrated by segment 42 of FIG. 4. Radar 12 and wheel 20 are considered to lie in the plane of the sketch in FIG. 1, although radar 12 may be located in front of or behind this plane for mounting convenience with some generally minor alteration in the radar output signal.

The radar output on interconnect 26 may comprise quadrature Doppler outputs on two separate conductors of interconnect 26 or upper sideband USB and lower sideband LSB signals as disclosed in U.S. patent application Ser. No. 09/388,785, “SSB Pulse Doppler Sensor and Active Reflector System”, to McEwan. The LSB and USB signals may also be output on two separate conductors of interconnect 26. The LSB output signals result from tread or other objects moving away from radar antenna 24, while the USB output signals result from tread or other objects moving towards the radar antenna. These separate single-sideband outputs are useful in eliminating antenna sidelobe responses and more particularly, in eliminating undesirable beats between the USB and LSB signals which would occur freely if not resolved into separate sideband channels.

Processor 28 processes the Doppler signal from interconnect 26 and may further comprise an alarm or display. Processor 28 may output processed signals on lines O₁ and O₂, each output representing directional information, control information, speed information, abnormality warning information, or other parameters related to the tire tread or its underlying cord, any of which may be used to alert the driver or to control a vehicle system, such as a braking system, an accelerator/engine system or a traction control system.

Since the tread has a pattern, a unique Doppler signal is generated for each unique tread pattern. If part of the tread is loose or missing, i.e., there is an abnormal part of the tread, the Doppler signal will exhibit a detectable difference between the normal and abnormal parts. If part of the tread is missing due to a totally separated tread lamination, then the radar Doppler output may produce no output or reduced output from regions of missing or separated tread. If there is a metal screw (or nail, etc) abnormally embedded in the tread, an abnormal signal is generated by the radar, as seen by the periodic bursts 44 of FIG. 4 which rise above the normal tread Doppler signal 42. Abnormal burst 44 repeats each time the screw falls within the radar beam, i.e., once each tire revolution. Processor 28 may detect this abnormality by comparing the average (or rms) amplitude of the full trace in FIG. 4 to the peak amplitude at points 44. If the peak-to-average level exceeds a threshold, processor 28 may sound an alarm, or display a fault condition to the driver, or may control a vehicle control system 30, such as the braking system, the traction system, the steering system or the engine system.

Radar 12 may be a CW Doppler radar, but is preferably a range-gated pulse Doppler radar, as seen in U.S. Pat. No. 5,966,090, “Differential Pulse Radar Motion Sensor,” to McEwan, or U.S. patent application Ser. No. 09/388,785, “SSB Pulse Doppler Sensor and Active Reflector System”, to McEwan, or for 24 GHz operation, U.S. Pat. No. 6,191,724, “Short Pulse Microwave Transceiver,” to McEwan or U.S. patent application Ser. No. 09/416,835, “Homodyne Swept Range Radar,” to McEwan. Radar 12 may also be an ultra-wideband radar as exemplified by U.S. Pat. No. 5,361,070, “Ultra-Wideband Radar Motion Sensor,” to McEwan or U.S. Pat. No. 5,805,110, “Impulse Radar with Swept Range Gate,” to McEwan. In the case where the radar emits a series of individual impulses, the Doppler effect pertains to a shift in the pulse amplitude or position of ½ cycle of RF, as opposed to conventional pulsed RF radar where a packet containing a number of RF sinusoids is emitted and reflected by the tread with a Doppler shift on the RF sinusoids. Regardless of whether the radar employs pulsed RF or impulses, a detected Doppler shift in the kilohertz range implies the radar must coherently integrate repetitive reflections over a period of time at least as long as one detected Doppler output cycle, or typically over a span of 100 μs. For a radar pulse rate of 2 MHz, 200 radar pulse repetitions are coherently integrated. This process is elaborated upon in the above-cited patents and applications.

A range gate is formed by either a pulse Doppler radar or an impulse radar, as indicated by R₁ and R₂ in FIG. 1. The receiver in radar 12 is gated to only accept echoes from a region defined by the space between R₁ and R₂ in the downrange direction. The beamwidth of antenna 24 limits coverage in the crossrange direction. Thus, the combination of the range gate and the antenna beamwidth defines a zone that screens out nearby clutter such as wheel well motion, ground motion, wheel rim motion, etc.

When the radar is alternately mounted in a position as shown by radar 12 in dashed lines, the beam-to-tread motion angle is substantially 90 degrees and the Doppler output is considered to be zero since the cosine term in the Doppler frequency equation is cos(90°)=0. This is a zero Doppler geometry. However, the radar is still responsive to changes in tread reflectivity, which varies as the tread pattern is swept past the radar beam, as seen in an experimental response plotted in FIG. 5. Thus, we can loosely call this zero Doppler condition a form of Doppler, since the signals are similar to those for which a does not equal 90°. However, this apparent zero Doppler condition may also include antenna sidelobe responses, which at not in a zero Doppler geometry. The tread pattern signal appears as somewhat periodic wavelets having repetitive peaks 46. The pattern is not precisely repeated since fine radar-to-tread range variations on the order of ⅛ wavelength, or 1.5 mm, can create substantial changes in the detected signal. These variations can be substantially removed with quadrature Doppler processing. Processor 28 may incorporate a wavelet transform processor to improve the tread counting signal or increase the reliability of abnormality detection. Processor 28 may also comprise, for example, a zero crossing detector coupled to a counter to count the number of zero crossings per second, which on average relates to wheel speed.

FIG. 2 depicts a tire sidewall monitoring arrangement 40 of the present invention. Radar 12 beams RF at the sidewall 32 of a tire and RF reflections are detected and output on interconnect 26 to processor 28, which may further provide outputs O₁ and O₂ for purposes as previously described. Radar 12 may be mounted at an arbitrary angle φ. With φ=0, as shown in FIG. 2, any variation in range between sidewall 32 to radar antenna 24 will create a detectable change in phase of the RF reflections. Thus, sidewall ballooning, tire run-out or embedded nails will change the phase of the RF reflections. Radar 12 may, in general, have modulation impressed on its transmissions, so the received phase shift from tire abnormalities can be conveniently measured on the modulation, as is known in the art of radar. Most abnormalities will repeat once each tire revolution and can be filtered with tracking bandpass filters tuned to the tire's rotational periodicity—or with digital processing using, for example, FFT processing. Once filtered, thresholds can be set within processor 28 to trigger an alarm, display information, or control a system of the vehicle.

FIG. 3 depicts a wheel rim speed monitor 50 of the present invention.

Radar antenna 24 is positioned (at an arbitrary angle θ from the normal) to direct a beam to spoke 22 of rim 18 (see FIG. 1 for clarity). The rim is either spoked or contains at least one structural member to cast a radar reflection that differs from the rest of the rim. As wheel 20 rotates, each spoke passes through the beam of radar 12 and produces a reflection, which is detected by radar 12 and output on interconnect 26 to processor 28. If there are 8 spokes, then radar 12 will output 8 pulses or bursts per revolution of the wheel. Reflections from a 2000 Volkswagen Beetle rim are shown in FIG. 6, which has “spokes” which are formed of circular openings in the rim. The periodic bursts 48 can be processed in processor 28 using, for example, envelope detection, followed by peak detection and fractional maximum threshold detection to provide a digital pulse train for counting and wheel speed determination. Wheel speed information can then operate an alarm for signaling wheel slip or lockup, or for traction control via outputs O₁, O₂ in the case of a 4-wheel vehicle or a racing vehicle.

An 18-wheel truck may experience wheel lockup of a rear trailer wheel without the driver's knowledge. A simple non-contact monitor of the present invention can sense a non-rotational condition, and perhaps in comparison with the other wheel speeds on the truck, can determine an abnormal or dangerous lockup condition (i.e., wheel skidding), and signal the driver or control a system such as the anti-lock braking system.

While the invention may be implemented directly on a vehicle to provide the driver with realtime information about tire condition and to trigger various safety alarms or control a vehicle system, the invention may also be implemented on a test stand to which tires and/or wheels are mounted during manufacture or during testing.

For example, the invention may be used on wheel balancing equipment responsive to out-of-round or run-out error signals from radar 12 or processor 28.

A primary advantage to radar over ultrasound or optical detection methods is environmental ruggedness. Neither ultrasonic nor optical sensing is suitable for automotive tire and wheel sensing since an overcoating of dirt, ice or snow on an ultrasonic transducer or optical lens will completely negate operation. In contrast, radar penetrates dirt, ice, snow and rain with little attenuation. Blowing wind, even wind created by a rotating tire, is a unique problem with ultrasonic sensing since wind and air turbulence can completely “blow away” ultrasonic echoes, resulting in no received signal at all.

Changes and modifications to the specifically described embodiments can be carried out without departing from the scope of the invention, which is intended to be limited only by the scope of the appended claims.

What is claimed is:

1. A vehicle or test stand mounted tire and wheel rim monitoring apparatus comprising:
a radar transceiver for transmitting RF signals to a rotating tire or wheel rim and for receiving RF echoes from the rotating tire or wheel rim to produce a radar output;
a processor for processing the radar output to provide an indication of a tire parameter or wheel speed.

2. The apparatus of claim 1 wherein the radar transceiver is a Doppler radar.

3. The apparatus of claim 2 wherein the Doppler radar is a pulse Doppler radar.

4. The apparatus of claim 2 wherein the Doppler radar is a quadrature radar.

5. The apparatus of claim 1 wherein the processor further comprises an alarm or display.

6. The apparatus of claim 1 wherein the processor output is a control signal which controls a system of a vehicle.

7. The apparatus of claim 1 wherein the radar transceiver is positioned so that the processor provides an indication of tire tread delamination or tire out-of-round or tire run-out conditions.

8. The apparatus of claim 1 wherein the radar transceiver is positioned so that the processor provides an indication of tire sidewall ballooning or tire wobble.

9. The apparatus of claim 1 wherein the radar transceiver is positioned so that the processor provides an indication of wheel rotation rate.

10. A method for vehicle or test stand mounted sensing of tire abnormalities or wheel speed, comprising:
transmitting RF to a rotating tire or wheel rim;
receiving RF reflections from the rotating tire or wheel rim;
processing the received RF reflections to detect a tire abnormality or wheel speed.

11. The method of claim 10 wherein processing the received RF reflections comprises processing Doppler reflections.

12. The method of claim 11 wherein processing the received RF reflections comprises processing quadrature Doppler reflections.

13. The method of claim 10 wherein the transmitted RF is directed to and the received RF reflections are received from a tire tread.

14. The method of claim 10 wherein the transmitted RF is directed to and the received RF reflections are received from a tire sidewall.

15. The method of claim 10 wherein the transmitted RF is directed to and the received RF reflections are received from a structural member of a wheel that casts a radar reflection that differs from the rest of the wheel.

16. The method of claim 10 further comprising controlling a vehicle system in response to the detected tire abnormality or wheel speed.

17. A tire or wheel monitoring apparatus comprising:
a radar transceiver positioned in a fixed relationship to a rotating tire or wheel and for transmitting RF signals to the rotating tire or wheel for receiving reflected echoes from the rotating tire or wheel;
a processor connected to the radar transceiver for processing output signals from the radar transceiver to provide an indication of a tire parameter or wheel speed.

18. The apparatus of claim 17 wherein the radar transceiver is mounted on a vehicle.

19. The apparatus of claim 17 wherein the radar transceiver is mounted on a test stand.

20. A tire or wheel monitoring apparatus comprising:
a radar transceiver positioned in a fixed relationship to a rotating tire or wheel for transmitting RF signals to a selected portion of the rotating tire or wheel and for receiving reflected echoes from the selected portion of the rotating tire or wheel;
a processor connected to the radar transceiver for processing output signals from the radar transceiver to provide an indication of a tire parameter or wheel speed.

21. The apparatus of claim 20 wherein the radar transceiver is mounted on a vehicle.

22. The apparatus of claim 20 wherein the radar transceiver is mounted on a test stand.

23. A tire or wheel monitoring system for vehicles, comprising:
a radar transceiver mounted on the vehicle to transmit RF signals to a rotating tire or wheel and to receive reflected echoes from the rotating tire or wheel;
a processor connected to the radar transceiver for processing output signals from the radar transceiver to provide tire condition or wheel speed information;
a vehicle control system connected to the processor to control a vehicle system in response to the tire condition or wheel speed information.
